(19) United States
(12) Patent Application Publication
(10) Pub. No.: US 2012/0310766 A1
(43) Pub. Date: Dec. 6, 2012

(54) Comprehensive Multivariable Auction Platform and Process (CMAPP)

(76) Inventor: Leo Soong, Walnut Creek, CA (US)

(21) Appl. No.: 13/483,671

(22) Filed: May 30, 2012

Related U.S. Application Data
(60) Provisional application No. 61/492,435, filed on Jun. 2, 2011.

(51) Int. Cl. G06Q 30/08

(52) U.S. Cl. 705/26.3

(57) ABSTRACT

A system and method of conducting an electronic auction allows participants to create multivariable auctions for participants having different locations having a positive or negative need of auctioned goods. The system may create initial bids to beat for all participants after the system calculates current costs relevant to each participant. After each bid, the system reviews the position or state of all participants, and outputs bids to beat that would result in an economic gain for the respective participants. The system may be configured to generate maps for the transport of goods and initial transport prices by acceptance of data from transportation bidders. After completion of an auction, a full system audit trail may be made available to verify the integrity of the auction and fees charged by the system. In a construction site embodiment, quarries may be integral partners and assist in establishing initial or default bids.

### CROSS-REFERENCE TO RELATED APPLICATIONS

This application is a utility application based upon U.S. patent application Ser. No. 61/492,435 filed on Jun. 2, 2011. This related application is incorporated herein by reference and made a part of this application. If any conflict arises between the disclosure of the invention in this utility application and that in the related provisional application, the disclosure in this utility application shall govern. Moreover, the inventor incorporates herein by reference any and all patents, patent applications, and other documents hard copy, electronically cited or referenced to in this application.

### BACKGROUND OF THE INVENTION

(1) Field of the Invention

The invention generally relates to auction systems. More particularly, the invention relates to electronic multivariable auction systems.

(2) Description of the Related Art

Other electronic auction systems are known in the related art. For example, U.S. patent application publication 2001/0027431 by Rupp et al published on Oct. 4, 2001 discloses electronic systems of cataloging, buyer-bidding auctions, seller-bidding auctions and exchange marketplaces.

U.S. Pat. No. 8,135,625 by Leichter granted on Mar. 13, 2012 discloses a data processing system connected to bidder terminals connected to a data network.

U.S. Pat. No. 7,903,977 by Fisher et al granted on Jul. 19, 2011 and assigned to eBay discloses a method and system for facilitating electronic auctions for a plurality of bidders and a plurality of merchandise items.

U.S. Pat. No. 8,036,949 by Nassiri issued on Oct. 11, 2011 discloses an animated auctioneer that interfaces with auction bidders to facilitate a live on-line auction.

The related art fails to provide means or methods of accommodating time, location or cascading adjustments to auction variables. The related art fails to provide for incremental physical movements of items and fails to establish minimum bids to facilitate market advantages to both bidders and sellers. The related art fails to provide allocations between participants to share economic advantages created by participant actions. The related art fails to disclose, suggest or anticipate the attributes of the disclosed embodiments of the present invention. Thus, there is room in the art for the present invention.

### BRIEF SUMMARY OF THE INVENTION

Various embodiments of the present invention overcome shortfalls in the related art by presenting an unobvious and unique combination and configuration of servers, databases, data manipulations, data associations, specialized processors, processing units, computer readable storage mediums, modules, machine readable executable instructions and other components to facilitate complex real world transactions having movements and incremental movements of tangible material and other actions and attributes.

One of the advantages of the various embodiments of the present invention is the artful use and manipulation of multiple and dynamic variables often found in the exchanges of goods and services in industries with critical path time windows, location dependent delivery points, multiple supply locations, multiple storage locations, multiple buyers and sellers and economic advantages created by transactions. Disclosed embodiments are especially useful in commercial environments with multiple bidders and suppliers who may benefit by having their transactions linked together to achieve efficiencies spanning over multiple projects, multiple locations and time windows.

In one contemplated embodiment, transactions spanning several construction sites are facilitated and accommodate varying transportation costs, time windows, and interdependent bids for supply, intake, storage, supervision and other tasks and materials incident to a construction project or a series of construction projects. Bids may include positive numbers to purchase goods or negative numbers to pay others to remove goods. Participants may carry a negative balance for a commodity, such as soil and then bid for such a commodity in subsequent phases of an auction. As soil is transported or bided for transport from one location to another, a participant in need of soil will see changes in transportation costs and offers of sale.

Embodiments of the disclosed invention process data such that each bidder sees their respective “price to beat” screen shot or output that accounts for a bidder's unique circumstances, cost factors and interdependences with changing supply, demand and location variables. Each auction produces an audit trail or other appropriate documentation to authenticate the integrity of a transaction, the process defining the transaction and the fees charged by the operators of the system.

Embodiments of the disclosed system may be configured to autonomously issue bids on behalf of a participant who wishes to take breaks from personally interacting with the system. Such autonomous or automatic bids are made to improve the position of the indisposed bidder.

Embodiments of the disclosed system may be configured to retract bids that have been beaten by another party. A beaten bid may generate a new situation or auction map for review of the beaten bidder. Due to the complexity of the multi-variable auctions and interrelated auctions conducted by the system, presenting a new situation to a beaten bidder represents a new area in the art.

Embodiments of the disclosed system may be configured to avoid or circumvent map charges charged by various vendors or online services. In some contemplated embodiments, on-line maps are sometimes used to calculate distances which in turn are used to derive shipping costs. In a contemplated embodiment that eschews costly commercial maps, outside shipping vendors submit a time/distance vs. cost matrix, including their own starting locations to enable the system to calculate shipping costs between given locations. Thus, the data provided by outside shipping vendors may populate databases storing relative distances, routes and shipping costs. Where data is not available from shipping vendors, default rates may be used by the system. As a fallback position, commercial databases may be used to provide initial distance and/or route information.

In yet another contemplated embodiment, a disclosed system accepts and analyzes offers of negative value for unwanted commodities. Potential acquires may bid down the amount offered for removal.

These and other objects and advantages will be made apparent when considering the following detailed specification when taken in conjunction with the drawings.

### BRIEF DESCRIPTION OF THE DRAWINGS

FIG. 1 is a schematic view of an auction system consistent with the principles of the disclosed invention.

FIG. 2 is a schematic view of an Auction Platform Manager consistent with the principles of the disclosed invention.

FIG. 3 is a schematic view of a contemplated embodiment and sample transaction consistent with the principles of the disclosed invention.

FIG. 4 is a schematic view of a contemplated embodiment and sample transaction consistent with the principles of the disclosed invention.

FIG. 5 is a schematic view of a contemplated embodiment and sample transaction consistent with the principles of the disclosed invention.

FIG. 6 is a schematic view of attributes of a contemplated Auction Platform Manager

FIG. 7 is a schematic view of an Auction Platform Manager in communication with other components

FIG. 8 is a schematic view of additional components contained within an Auction Platform Manager

FIG. 9 is a schematic view of a Map Maker module

### REFERENCE NUMERALS IN THE DRAWINGS

10 Auction Platform Manager sometimes referred to as “the system”
20 audit trail
30 supply bidders
31 supply bids
32 processing of supply bid variables
33 transmission of adjusted supply bid data
40 demand bidders
41 demand bids
42 processing of demand variables
43 transmission of adjusted demand bid data
50 storage bidders
60 service bidders
70 N bidders, for other service and material bidders
100 quarry A sometimes referred to as “QA”
110 quarry B sometimes referred to as “QB”
200 construction site A, sometimes referred to as “A”
210 construction site B, sometimes referred to as “B”
220 construction site C, sometimes referred to as “C”
230 construction site D, sometimes referred to as “D”
300 a processor equipped with system instructions
301 a second processor equipped with system instructions
400 a database of construction sites
401 a database of transportation providers
402 a database of soil locations and soil attributes
403 a database of system users
404 a database of past transactions
405 a database of current auction states
500 a non-transitory machine readable medium
501 executable instructions, machine readable
550 a plurality of modules
600 internal application to create complementary auctions
650 internal communication network
651 gateway to an external communication network
700 a plurality of auction records
750 a plurality of servers
800 third party shipping vendors
801 third party map suppliers
802 system administrators
803 web based bid forms
804 a plurality of web forms
850 system controller
950 Map Maker
951 user input module to Map Maker, input used to draw map
952 map drawing module
953 map drawn by the Map Maker 950 of the system 10

### DETAILED DESCRIPTION OF EMBODIMENTS OF THE INVENTION

The following detailed description is directed to certain specific embodiments of the invention. However, the invention can be embodied in a multitude of different ways and their equivalents. In this description, reference is made to the drawings wherein like parts are designated with like numerals throughout.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

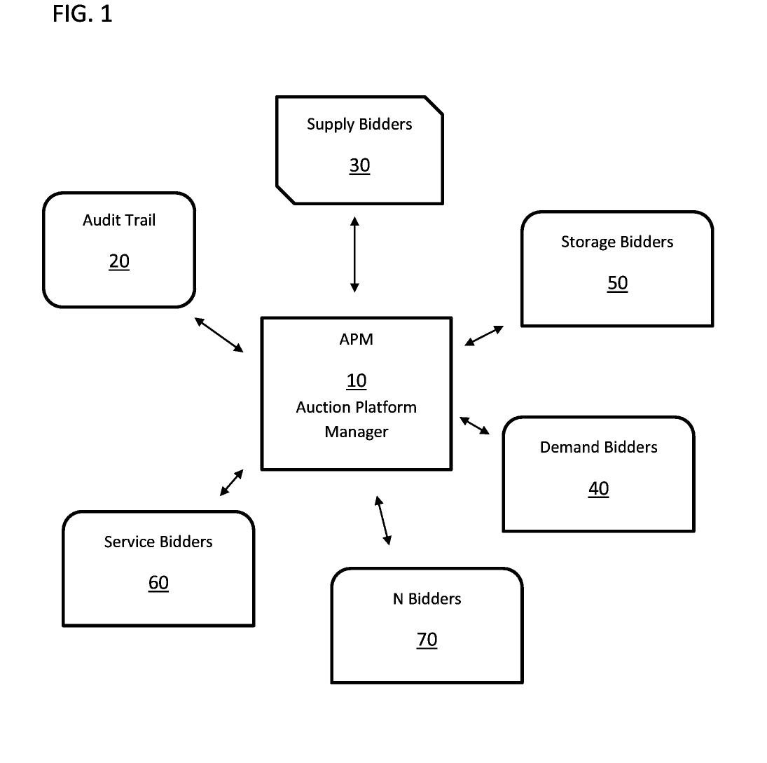

FIG. 1 presents a flow of data between an APM or Auction Platform Manager 10, supply bidders 30 and demand bidders 40. An APM 10 is in communication with a database and related functions to create an audit trail 20.

Each transaction produces documentation, sometimes called an audit trail 20 that may be used to verify that system protocols were followed and that no participant was given an unfair advantage. Those wishing to view an audit trail 20 may be required to agree to terms of non-disclosure and to report only if system rules were followed for a particular transaction.

Supply bidders 30 have goods or services to offer to demand bidders 40. Supply bidders may enter time frames, locations of supply, shipping costs, storage costs, security costs, quantities of supply and other variables that may shift during the life of the auction process. The values of variables may be dependent upon the progress of the auction. For example, other bids or transactions may change the quantities of available product, locations of product or shipping costs. Intermediary transactions may be used to time shift the supply of material as material is contracted to move to another location. Intermediary transactions or bids may also lower shipping costs as goods are set to move closer to a final destination. Transactions may be linked together to orchestrate a series of transactions yielding improved market efficiencies.

Demand bidders are desirous of obtaining goods and services within certain parameters or variables such as time, location, weather, price and other factors. By integrating a broad spectrum of contemplated transactions, demand bidders using embodiments of the disclosed system may achieve exceptional and unexpected results as goods and services may be incrementally moved closer to a demand bidder. For example, a demand bidder wanting soil may find that other soil transactions or bids within the system result in soil being available at a closer location.

Embodiments of the invention contemplate any number of bidders and any number of categories of bidders, as shown by N bidders 70. Moreover, storage bidders 50 and service bidders 60 may be used to time shift and/or location shift the auctions of various goods, such as soil.

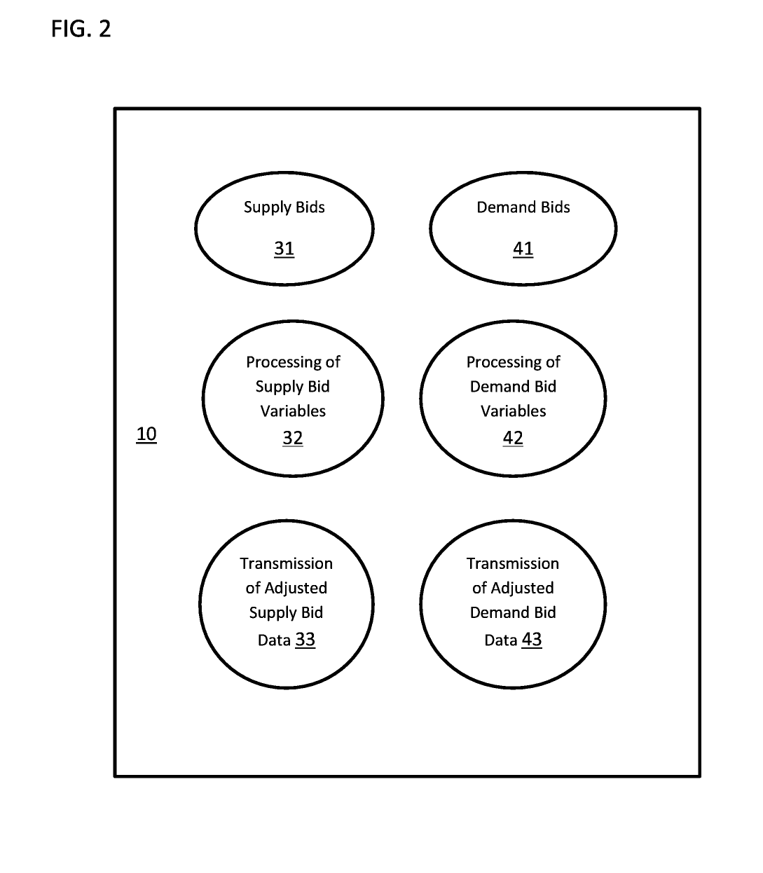

FIG. 2 discloses certain attributes of an Auction Platform Manager 10 to achieve advantages over the prior art. An Auction Platform Manager may have a specialized processor, a processor containing system instructions, a system of databases and methods of data manipulation and management. In one contemplated embodiment, an Auction Platform Manager may be similar to what is shown in FIG. 2, wherein supply bids 31 are entered and subject to processing 32 wherein supply bid variables are considered, stored and compared to other bids in an effort to link bids, reflect changing market conditions, provide intermediary steps to move products or to perform other functions. During the auction process, the transmission of adjusted supply bid data 33 may be sent to interested parties.

Demand bids 41 are also accepted by the APM 10 and processed 42 such that demand bid variables are entered into the appropriate databases and compared to other bids to possibly obtain economic advantages for the users of the disclosed system. After processing, the APM may transmit adjusted demand bid data 43.

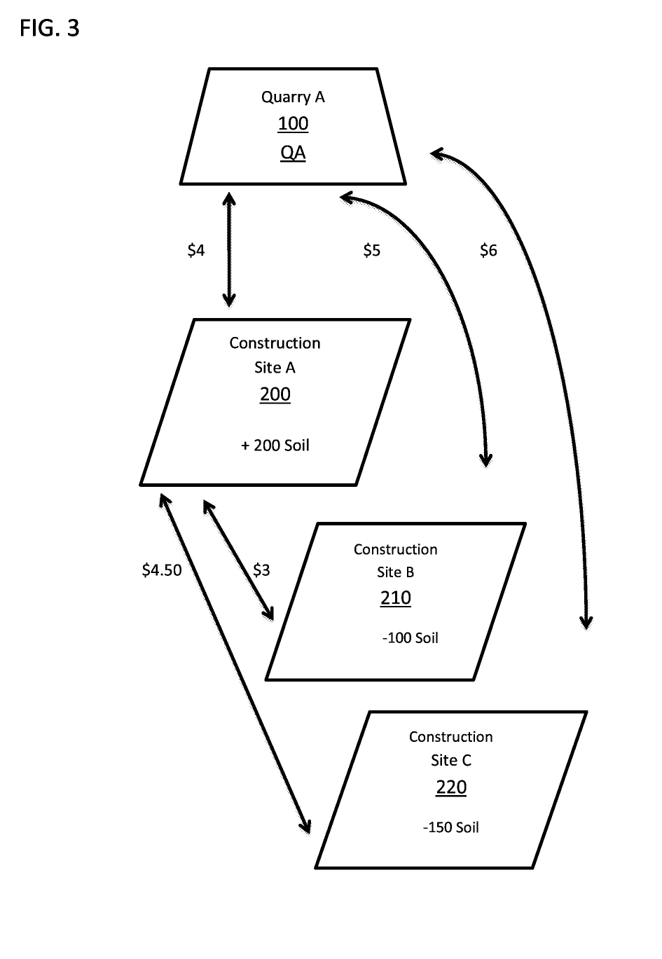

FIG. 3 presents a visual aid in describing a possible series of bids and transactions occurring in the field of construction. But, the disclosed embodiments are also useful in other areas of commerce and not limited to the construction industry. The example herein considers the needs of construction projects requiring the import or export of soil to comport with changing construction conditions. Construction projects often have stringent time schedules for the import or export of soil and delays in construction can create severe economic disadvantage to a construction company.

As transportation costs often exceed the market value of the transported soil, in the prior art, construction companies would spend significant time contacting other construction companies in an effort to locally obtain or deposit soil. Multiparty movements of soil, or incremental transactions, were simply not feasible in the prior art. The present invention overcomes shortfalls in the prior art by deftly coordinating time shifts and location movements among unrelated parties such that each participant enjoys maximum market efficiencies.

FIG. 3 presents a rock quarry A 100 having soil for sale to any purchaser for $4 per cubic yard and a willingness to accept soil at a charge of $2 per cubic yard. In this example, the rock quarry may be considered to be a supply bidder 30, storage bidder 50 and a demand bidder 40.

The Auction Platform Manager 10 or APM may negotiate with the rock quarry for various commission rates and sale rates, or with disclosure, automatically build commissions into bid results. The APM may also negotiate with the various bidders for commission rates and sale rates. The APM also comprises various protocols preventing auction participants from circumventing the system to avoid paying commissions.

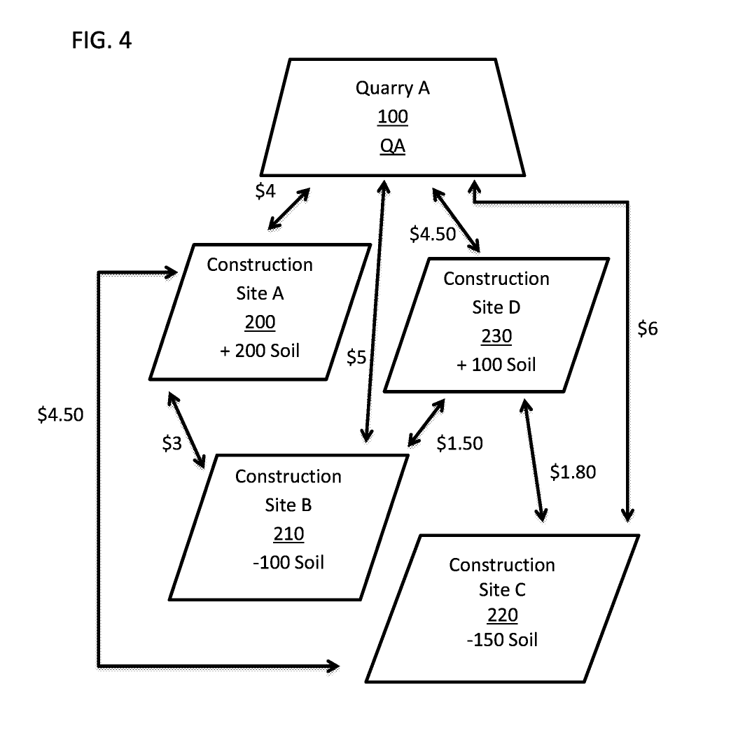

Referring to FIG. 3 and FIG. 4, construction sites A, B, C and D are shown to be distant from QA or Quarry A 100. Construction site A 200 has an excess of 200,000 cubic yards of soil, construction site B 210 is in need of 100,000 cubic yards of soil, construction site C 220 is in need of 150,000 cubic yards of soil and construction site D 230 has an excess of 100,000 cubic yards of soil.

In this example, a trucking company may be considered to be a service bidder 60, and has agreed to transport soil between the following locations at the following rates per cubic yard:

QA to construction site A $4
QA to construction site B $5
QA to construction site C $6
QA to construction site D $4.50, construction site D shown in FIG. 4

### A to B $3

### A to C $4.50

### B to D $1.50

### C to D $1.80

Multiple trucking companies are contemplated, and the system would accept bids for each route, or would automatically calculate transportation costs for each route using time/distance cost matrices and trucking depot starting points for each transportation service bidder. Bids may incorporate an agreed commission for the owners or operators of the system. To more clearly explain the complex attributes of the present system, commissions will be mostly ignored in the system examples and transaction scenarios described herein. For purposes of simplification system commissions will be incorporated into transportation and material transactions.

As stated above, QA or quarry A 100 will sell soil for $4 per cubic yard and will accept soil at a charge of $2 per cubic yard.

Phase I.

Initially referring to FIG. 3, a first contemplated transaction may start with the participation of any construction site, quarry, trucking company or other participant. In one contemplated scenario, constructions site A 100 or “A” places a bid query for the export of 200,000 cubic yards, and has not imposed a minimum bid. The system will place a default bid of $1.2 million (based on being charged $400,000 for quarry services and $800,000 for trucking services). In other words, the trucking charge of $4 per cubic yard (shown as $4 between construction site A 200 and quarry A 100) for 200,000 cubic yards results in a trucking charge of $800,000 and the quarry charge of $2 per cubic yard to accept 200,000 cubic yards of soil results in a quarry fee of $400,000. In this first salvo, A is faced with a cost of $6 per cubic foot for soil removal.

In this initial phase, quarries may play an important role in setting default bids. In one contemplated embodiment, default bids may be set such that economic advantages are apportioned between a buyer and seller. After the initial phase of setting default bids, all bids are purely market driven.

Phase II.

Construction site B 210 or “B” now enters with a bid query for the import of 100,000 cubic yards of soil. The system will calculate that based on what the default bid to A is, the price for B to beat is to accept to be paid less than $300,000 to receive 100,000 cubic yards of soil. If B is paid less than $3.00 per cubic yard to accept import of 100,000 cubic yards, A's position is improved since A would be paying $3 per cubic card for trucking to B, and less than $3.00 to B for accepting his export.

In other words, consider the trucking charge of $3 dollars per cubic yard to move soil from site A to site B. If B were to accept $3 per cubic foot to take soil from A, then A's cost of removal would be $6 dollars per cubic foot, the same price initially set by the system.

To offer an economic advantage to A, upon B's entry to the system, B is shown in a system display or system output, a bid to beat in the form of a statement showing the need to accept less than $3 dollars a cubic foot for soil held by A. Since B wants to import 100,000 cubic feet of soil, B is shown a bid to beat of accepting less than $300,000 to take soil from A. In this scenario, B is not shown the trucking cost, but the system considers the trucking cost to analyze A's position.

Phase III.

B now enters a bid to be paid $200,000 to accept 100,000 cubic feet of soil from A. For the 100,000 cubic feet of soil taken by B, A will pay $2 per cubic yard to B ($200,000) and a trucking charge of $3 dollars per cubic yard ($300,00), resulting in cost of $5 per cubic yard or $500,000 thousand dollars.

A now sees upon his system display or system output, that his cost of exporting 200,000 cubic feet of soil has now dropped from 1.2 million to $1.1 million. A's new cost of export is derived as follows:

100,000 cubic feet of A's soil is slated for acceptance at quarry A 100 at a cost of $6 dollars per cubic foot or $600,000; and
the other 100,000 cubic feet of A's soil is slated for acceptance by B at a cost of $5 dollars per cubic yard or $500,000 dollars. Due to B's entry in to the auction, A is set to save $100,000.

Phase IV.

Construction site C 220 or “C” now enters the bidding process requesting import of 150,000 cubic yards of soil. The system shows that C's price to beat or bid to beat is to be paid less than $125,000 to accept 150,000 cubic yards, resulting in a rate of $0.83 per cubic yard ($125,000/150,000 cubic yards=$0.83/cubic yard). But, C's default bid is generated after adding a system applied minimum bid increment, which is $0.10 per cubic yard in the current example.

In other words, C starts with a system generated default bid based upon best transportation and quarry pricing of $10 per cubic yard and then the system applies a minimum bid increment. The system generated bid to beat and default bid to C are the products of unobvious and new mechanisms herein described. The system generated price to beat or bid to beat and default bid delivered to C are derived as follows:

Consider:

A ships 100,000 cubic feet of soil to B, cost $500,000.

Trucking cost is $3 per cubic yard times 100,000 cubic yards equaling $300,000.
Soil payment from A to B (as discussed above) is $2 per cubic yard×100,000 cubic yards equaling $200,000 dollars. The total cost of 100,000 cubic yards of soil moved from A to B is $500,000.

A ships 50,000 cubic yard of soil to quarry A 100 or QA, cost $300. Trucking cost is $4 per cubic yard×50,000 cubic yards equaling $200,000. Quarry fees are $2 per cubic yard×50,000 cubic yards equaling $100,000. The total cost of 50,000 cubic yards of soil moved from A to QA is $300,000.

The two proposed system generated transactions above show that in the current state of the auction, A has a current cost of $800,000 dollars to dispose of 150,000 cubic yards of soil. The system used C's need of 150,000 cubic yards of soil in calculating A's cost relevant to C's participation in the system. This is one of the mechanisms of the subject invention that overcome shortfalls in the related art. This unobvious system attribute generates unexpected results to the benefit of the auction participants.

In execution of this system mechanism in response to C's entry into the auction, the system notes that A's average cost to dispose of 150,000 cubic yards of soil is $800,000/150,000 cubic yards equaling $5.333 per cubic yard.

The system then derives proposed transactions that would provide an economic benefit to A in terms of possible actions by C.

The system considers the trucking cost between A and C of $4.50 per cubic yard. A movement of 150,000 cubic yards of soil from A to C would have a trucking cost of $675,000. The system then compares A's current proposed cost of $800,000 to figure out what action by C would be of interest to A.

The system notes that the difference between A's current state of paying $800,000 versus the trucking cost from A to C of $675,000 is $125,000 dollars. If C were to accept 125,000 dollars for A's shipment of 150,000 cubic feet of soil, A would have two equally expensive bids equaling $800,000 dollars each.

The system may be configured to accept or generate minimum bid increments so as to prevent participants from entering trivial bids. In one contemplated example, $0.10 per cubic yard is set as a minimum bid increment.

The system presents to C a price to beat of being paid $125,000 or less to accept 150,000 cubic yards of soil. In the present example, the bid to beat price plus the minimum bid increment of $0.10 per cubic yard for C represents an incremental economic benefit to A in the amount of $15,000.

Returning to the present example wherein the system generates a message or screen view showing that C's bid to beat is to accept less than $125,000, or in the case of a $0.10 per cubic yard minimum bid increment, $110,000.

C figures out that C's alternative is to purchase soil from QA at a total cost of $10 dollars per cubic yard for a total expenditure of $1,500,000. This potential out of pocket cost to C comprises a cost of $4 per cubic yard for soil purchased from QA and a trucking cost of $6 per cubic yard moved between QA and C. This alternative represents a catastrophic set back to C.

In the present scenario, C is presented with an opportunity to accept a minimum payment of $110,000 to receive his need of soil and a possible future state, if C is outbid for A's soil, an opportunity to pay $1,500,000 for soil from QA.

Phase IV.

C considers his own situation and his feel for the market to assess the likelihood of being outbid for A's soil and C decides be proactive offers to pay $1 per cubic yard. Thus, instead of agreeing to be paid $110,000 to accept soil, C has agreed to pay $150,000 for the delivery of 150,000 cubic yards of soil. C's bid may be considered a negative bid in light of the system's proposed bid. Such negative bids are well handled by the disclosed system.

C's proactive bid has changed A's current cost to dispose of all of his 200,000 cubic yards of soil to $775,000. The system displays this value to A and the system finds A's new cost by adding:

A's cost of sending 50,000 cubic yards to B, $150,000 for trucking and payment to B of $100,000 equaling $250,000; and

A's cost of trucking 150,000 cubic yards to C, $675,000 less the proposed payment from C of $150,000 equaling $525,000.

A's cost is now $775,000. 50,000 cubic yards to B at $250,000 and 150,000 cubic yards to C at $525,000. A has an average cost of $5 dollars per cubic yard going to B and an average cost of $3.50 per cubic yard going to C.

Phase V.

The system refreshes all displays and presents to B's system interface the unfortunate news that B prior bid now commands delivery of only 50,000 cubic yards of soil. B is now faced with a shortfall of 50,000 cubic yards.

The system may generate an auction status page for display to all participants, and show that construction site B is currently scheduled to purchase 50,000 cubic yards at a price received (negative price paid) of $100,000; and that B has a need for 50,000 cubic yards not yet fulfilled.

The system presents a private display or private output to B showing that B has a bid to beat of accepting less than $1.25 per cubic yard of soil delivered to B. The system engages in several unobvious steps to derive this output, the steps being described below. Based in part by the unobvious nature of the steps herein, the system produces unexpectedly good results for the participants of the system.

In assembling the next private output to B, the system considers:

B obtains his first 50,000 cubic yards by accepting payment of $2.00 per cubic yard according to the prior bid to A. Thus, B would receive from A $100,000 for acceptance of 50,000 cubic yards of soil from A. As the system does not want B to bid against himself, this transaction is not disturbed.

For the remaining 50,000 cubic yards to B, the system finds the best price for B considering all bided transactions by others. The system finds that B's best opportunity is to disrupt part of A's currently bided transaction with C. As described above, C's current bid leaves A with a net cost of $3.50 per cubic yard. Thus, B's next bid to beat must result in A obtaining a lower price of soil disposal.

The system reviews the trucking cost between A and B to consider a fixed cost outside of the control of B. The trucking cost between A and B is $3 per cubic yard.

The system considers that B could bid zero dollars per cubic yard for delivery of 50,000 cubic yards from A. Such a bid would result in lowering A's cost to $3 per cubic yard for the 50,000 cubic yards sent to B, the sole cost being transportation.

The system then finds a proposed bid by B that would result in an expense equal to A's current expense of $3.50 per cubic yard for soil sent to C. Considering trucking costs of $3 per cubic yard, there is a spread of $0.50 per cubic yard between the trucking cost of transport between A and B and A's current expense of sending soil to C. The spread of $0.50 per cubic yard equates to $25,000 dollars for 50,000 cubic yards.

They system then calculates B's total bid by adding $100,000 for the first 50,000 cubic yards and $25,000 for the second 50,000 cubic yards for a total of $125,000 for 100,000 cubic yards. This base bid equates to $1.25 per cubic yard. Thus, the system generates a display or output to B stating that B's price to beat is to accept less than $1.25 per cubic yard delivered to B.

Phase VI.

B then generates a bid of accepting $1.20 per cubic yard of soil delivered to B.

As a result of B's bid, C's prior bid commands only 100,000 cubic yards of soil. The system then reviews all of the prior bids and current costs and expenses of all parties and generates a new screen display or output to C comprising a bid to beat. Similar rounds of bidding and system outputs will continue until the auction ends.

Now referring to FIG. 4, and referring back to the start of Phase V, consider construction site D 230 or D offering to sell 100,000 cubic yards and having a transportation cost to Quarry A 100 or QA of $4.50 per cubic yard; transportation cost to construction site B of $1.50 per cubic yard; and transportation cost to construction site C of $1.80 per cubic yard.

The system considers the attributes of construction site D as well as the bid positions and attributes of all other participates. The system then generates an output (including an email or text notification) to B reporting that in view of construction site D's attributes, B may now enter a bid to fulfill B's entire requirement for 100,000 cubic yards by being paid $345,000 (50,000 cubic yards from construction site A for which he has a high bid to receive $100,000; and 50,000 cubic yards from construction site D at a price of $245,000. The system generates this output by execution of the following steps:

Review of D's current costs, which reveal D having a transportation cost of $4.50 per cubic yard and a quarry cost of $2 per cubic yard for a total cost of $6.50 per cubic yard. For removal of 50,000 cubic yards, D has a current cost of $325,000.

Review of B's possible actions include consideration of the transportation charge of $1.50 per cubic yard trucked between B and D, and D's current total cost of $325,000 to send 50,000 cubic yards to QA. The system then ascertains the spread between D's current total cost and the lowest cost B could provide, without B paying out of pocket. Based on the transportation cost between B and D of $75,000, B could bid zero dollars and D would have a new cost of $1.50 per cubic yard.

The system then finds a bid by B that would present a breakeven point for D by finding the difference between the D's current cost of $325,000 and B's lowest cost of $75,000, the difference being $250,000.

In this scenario, B the system is configured to present minimum bid increments of $5,000 and adjusts the spread of $250,000 to $245,000. The adjusted spread of $245,000 is added to the value of $100,000 for soil from A and a figure of $345,000 is presented to B.

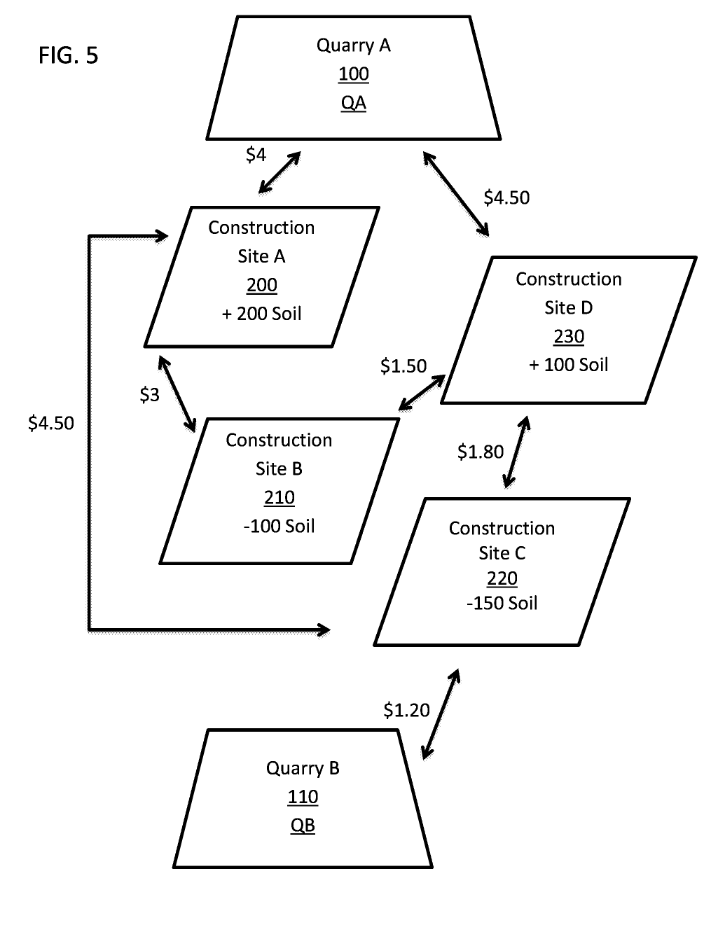

Referring to FIG. 5 a second quarry is shown as Quarry B 110 or QB. This second quarry adds to the complexity of contemplated transactions and further supports the needs for processors 300, non-transitory machine readable mediums 500, executable instructions 501 and other disclosed components and methods. In order to provide useful outputs the auction participants, the messages of the system and system calculations require a speed far faster than a human being may produce.

The system or APM 10 may determine minimum bid increments or decrements; and the APM 10 may set limitations on the number of rounds of bids and/or an ending time for an auction. As part of an audit trail 20, once an auction has closed, the bids will break-out the transportation expense so that participants with their own or lower cost trucking may supply their own transportation.

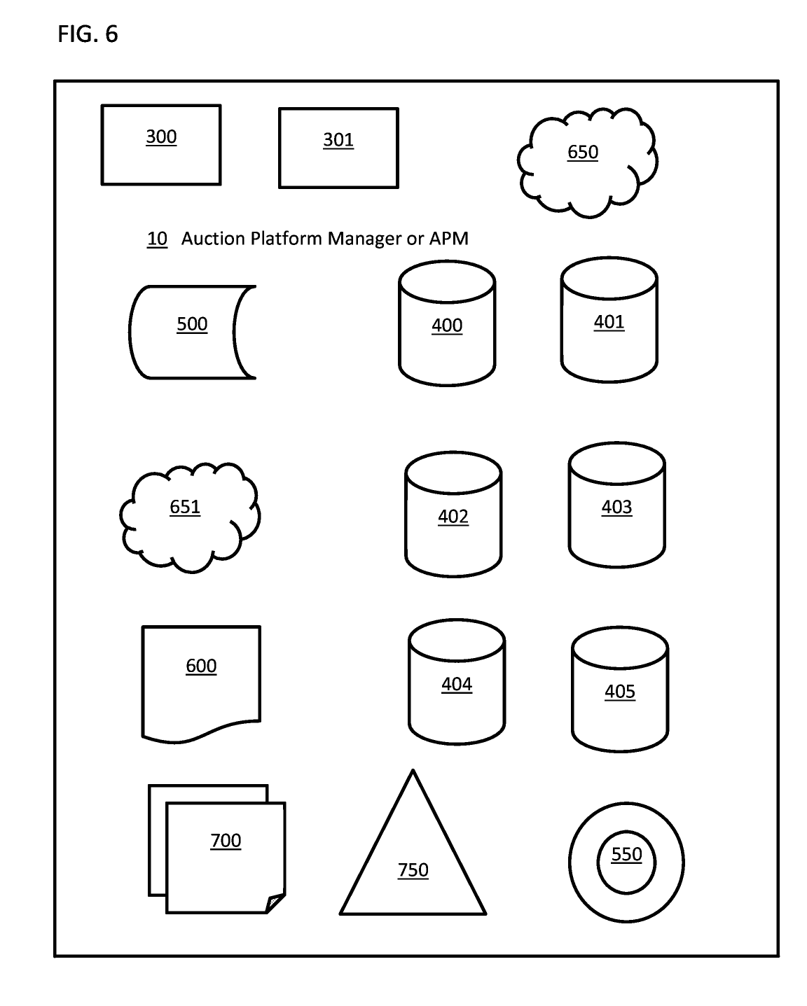

Referring to FIG. 6 additional components to the disclosed system or Auction Platform Manager 10 or APM are shown and include a processor 300 having system instructions, a second processor 301 with system instructions, an internal communication network 650 by which the components of the system or ARM may communicate, non-transitory machine readable medium 500 such as a hard drive, flash drive or other machine, a databases of construction sites 400, transportation providers 401, soil locations and soil attributes 402, system users 403, past transactions 404, current auction states 405 and others.

Machine readable, executable instructions 501 executing the functions of the system or APM may be entered directly into a server and database system or may be first integrated into a non-transitory machine readable medium 500. Details of past auctions are memorialized within a database comprising a plurality of auction records 700. A plurality of servers 750 assist in executing the system instructions 501. The APM may communicate with outside servers, auction participants and others by use of a gateway 651 to a communications network.

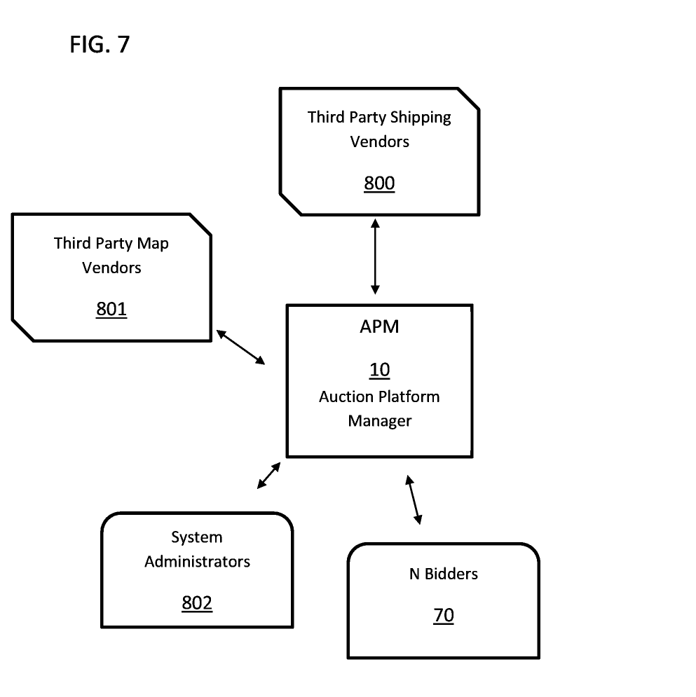

Referring to FIG. 7, third party map vendors 801 are shown in communication with a disclosed APM 10. Other parties shown to be in communication with a APM are system administrators, third party vendors, such as shipping vendors 80 and a plurality or N number of bidders 70.

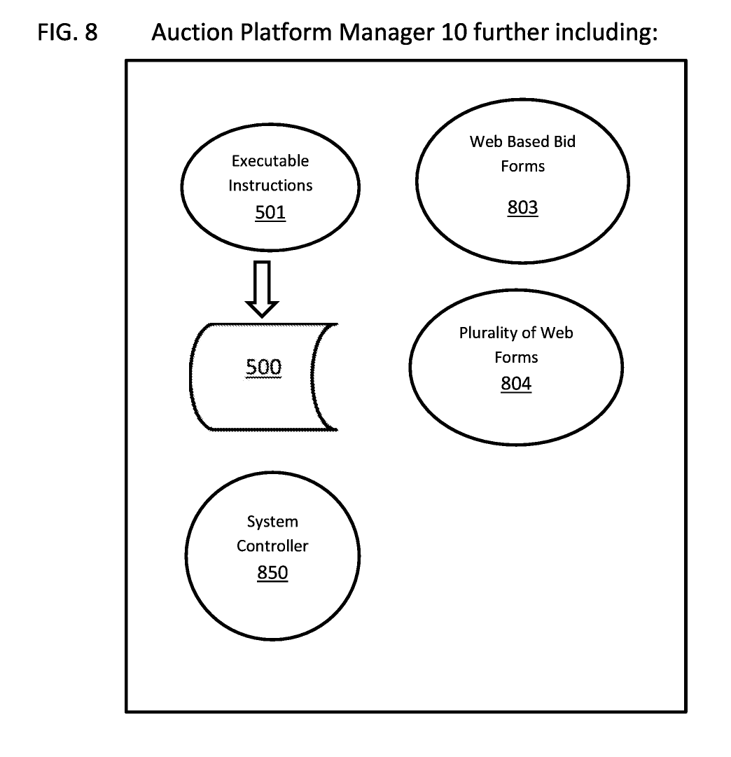

Referring to FIG. 8 shows other components of a disclosed APM 10 to include executable instructions 501 attached or embedded into a non-transitory machine readable medium 500. A system controller 850 may direct the flow of information and the output of both private and public messages sent to auction participants or auction bidders. Users of the system may be presented with web based bid forms 803, and plurality of web forms 804.

Any participant demanding an audit of any auction will be entitled to nominate a Chartered Public Accountant acceptable to the APM, who will sign a confidentiality agreement, agreeing to report only on whether the auction was run according to the stated rules, and whether the APM earned more than the contracted fee on each auction.

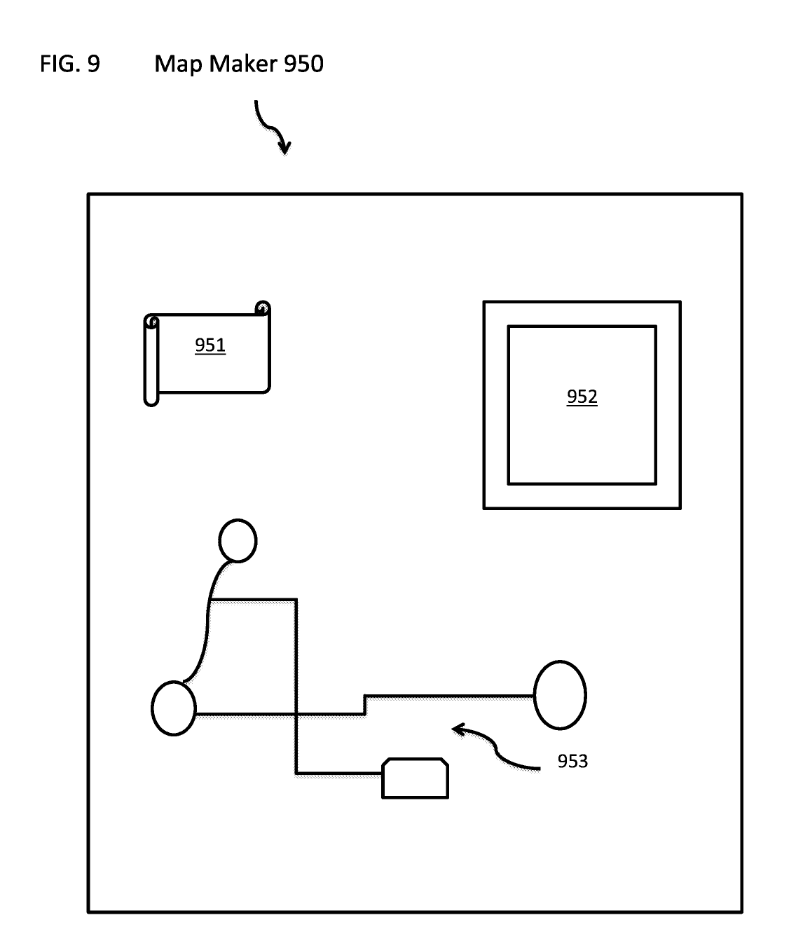

Referring to FIG. 9, the system or APM may also include a map maker 950 function, module or apparatus that constructs a map 953 based upon user input. The map maker 950 may comprise a user input 951 module wherein transportation providers input proposed routes and fees. The map drawing module 952 accepts input from the user input module to produce a map of auction items, locations and routes, such as the system generated may 953 shown in FIG. 9. The disclosed map maker 950 avoids the use of commercial online mapping services that may raise operating costs.

Embodiments of the disclosed system may include a preemptive bid price feature wherein an auction participant commits to sell immediately to any and all bidders up to a quantity limit and at a price set by the auction participant.

The above examples of operation are not limiting. The use of specialized databases, processors, function calls, various computer readable mediums and other components is contemplated.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

Any and all the above references and U.S. patents and applications are incorporated herein by reference. Aspects of the invention can be modified, if necessary, to employ the systems, functions and concepts of the various patents and applications described above to provide yet further embodiments of the invention.

Embodiments of the disclose system include the following items:

Item 1. An electronic auction system accommodating a plurality of bidders bidding on a plurality of goods found at a plurality of locations, the system comprising:

a) executable machine readable instructions 501 placed within a non-transitory machine readable medium 500, the medium 500 in communication with a processor 300 and the processor executing the executable instructions 501 by use of a plurality of servers 750, a database 403 of system users, the system users comprising supply bidders 30, demand bidders 40 and system administrators 802, the supply bidders having a plurality of auction items located in a plurality of locations and the demand bidders 40 bidding for items for delivery at different locations;

b) the executable instructions 501 including instructions embodying an auction platform manager 10 the auction platform manager 10 in communication with a plurality of modules 550, an internal communication network 650, and a gateway to an external communication network;

c) the executable instructions 501 allowing the auction manager platform 10 to generate auctions from requests of the system users, accept data from the supply bidders 30 and demand bidders 40, populate a database of current auction states 405 and to generate a plurality of auction records 700;

d) the executable instructions 501 further allowing the auction manager 10 to review the state of all supply bidders and demand bidders and to produce output to the supply bidders and the demand bidders revealing bids to beat, the bids to beat information derived by review of all bids and costs to all supply and demand bidders.

Item 2. The system of item 1 further including a map maker 950, the map maker comprising a user input module 951 and a map drawing module 952, the map maker 950 producing system maps 953 based upon input from the user input module.

Item 3. The system of item 2 wherein the user input module is in communication with transportation bidders.

Item 4. A method of operating a processor, a plurality of servers, a plurality of databases by execution of instructions stored on a non-transitory machine readable medium, the instructions comprising a method of operating an electronic auction, the method comprising the following steps:

a) accepting demand bids from demand bidders, the demand bidders having either a positive or negative demand for goods to be delivered or removed from their respective operation sites;

b) accepting supply bid from supply bidders, the supply bidders offering goods located at their respective operation sites;

c) accepting transportation bids from transportation bidders, the transportation bidders offering to transport goods between locations of goods and bidder operation sites;

d) deriving individualized bids to beat for all bidders by review a current auction state and calculating bids that would improve the position of the supply bidders and demand bidders; and

e) accepting additional bids and recalculating new bids to beat for transmission to the respective bidders.

Item 5. The method of item 4 further comprising the step of setting minimum incremental bids.

Item 6. The method of item 5 further comprising the step of setting bids to beat derived by review of current costs to all auction participants.

Item 7. The method of item 6 further comprising the steps of:

a) creating a map of demand bidder operation sites and supply bidder operation sites with the map showing transportation costs between operation sites, the data used for creating the map obtained from demand bidders, supply bidders and transportation bidders.

Item 8. The method of item 7 wherein private messages are sent on an individual basis to bidders and the messages comprising bids to beat and default bids, with the default bids derived by adding minimum bid increments to the bids to beat.

Item 9. The method of item 8 wherein auction items have a negative value and require payment for disposal.

Item 10. The method of item 9 wherein auction verification data is generated by the system verifying the integrity of the auction and fees charged by the system.

Item 11. The method of item 10 wherein initial default bids are set in the beginning of an auction.

Item 12. The method of item 10 wherein the initial default bids are set so as to either:

a) apportion economic advantages between prospective bidders; or

b) reflect best prices available.

Item 13. The method of item 12 used with quarries and construction sites.

Item 14. The method of item 13 wherein an auction participant may commit to sell to any and all bidders up to a quantity limit set by the auction participant and at a price set by the auction participant.

What is claimed is:

1. An electronic auction system accommodating a plurality of bidders bidding on a plurality of goods found at a plurality of locations, the system comprising:
a) executable machine readable instructions stored within a non-transitory machine readable medium, the medium in communication with a processor and the processor executing the executable instructions by use of a plurality of servers, a database of system users, system users comprising supply bidders, demand bidders and system administrators, the supply bidders having a plurality of auction items located in a plurality of locations and the demand bidders bidding for items for delivery at different locations;
b) the executable instructions including instructions embodying an auction platform manager, the auction platform manager in communication with a plurality of modules, an internal communication network and a gateway to an external communication network;
c) the executable instructions allowing the auction manager platform to generate auctions from requests of the system users, accept data from the supply bidders and the demand bidders, populate a database of current auction states and to generate a plurality of auction records; and
d) the executable instructions further allowing the auction manager to review the state of all the supply bidders and the demand bidders and to produce output to the supply bidders and the demand bidders, the output comprising bids to beat.

2. The system of claim 1 further including a map maker, the map maker comprising a user input module and a map drawing module, the map maker producing system maps based upon input from the user input module.

3. The system of claim 2 wherein the user input module is in communication with transportation bidders.

4. A method of operating a processor, a plurality of servers, a plurality of databases by execution of instructions stored on a non-transitory machine readable medium, the instructions comprising a method of operating an electronic auction, the method comprising the following steps:
a) accepting demand bids from demand bidders, the demand bidders having either a positive or negative demand for goods to be delivered or removed from their respective operation sites;
b) accepting supply bids from supply bidders, the supply bidders offering goods located at their respective operation sites;
c) accepting transportation bids from transportation bidders, the transportation bidders offering to transport goods between locations of goods and bidder operation sites;
d) deriving individualized bids to beat for all bidders by review of a current auction state and calculating bids that would improve the position of the supply bidders and demand bidders associated with a bid to beat; and
e) accepting additional bids and recalculating new bids to beat for transmission to the demand bidders and the supply bidders.

5. The method of claim 4 further comprising the step of setting minimum incremental bids.

6. The method of claim 5 further comprising the step of setting bids to beat derived by review of current costs of all auction participants.

7. The method of claim 6 further comprising the steps of:
a) creating a map of demand bidder operation sites and supply bidder operation sites with the map showing transportation costs between operation sites, the data used for creating the map obtained from the demand bidders, the supply bidders and the transportation bidders.

8. The method of claim 7 wherein private messages are sent on an individual basis to bidders and the messages comprise bids to beat and default bids, with the default bids derived by adding minimum bid increments to the bids to beat.

9. The method of claim 8 wherein auction items have a negative value and require payment for disposal.

10. The method of claim 9 wherein auction verification data is generated by the system, the auction verification data verifying the integrity of the auction and fees charged by the system.

11. The method of claim 10 wherein initial default bids are set in the beginning of an auction.

12. The method of claim 10 wherein the initial default bids are set so as to either:
a) apportion economic advantages between prospective bidders; or
b) reflect best prices available.

13. The method of claim 13 used with quarries and construction sites.

14. The method of claim 13 wherein an auction participant may commit to sell to any and all bidders up to a quantity limit set by the auction participant and at a price set by the auction participant.
